(19) United States
(12) Patent Application Publication
(10) Pub. No.: US 2013/0253575 A1
(43) Pub. Date: Sep. 26, 2013

(54) APPARATUS FOR RELIEVING NECK PRESSURE

(71) Applicant: Clarissa Baeza, Dallas, TX (US)

(72) Inventor: Clarissa Baeza, Dallas, TX (US)

(21) Appl. No.: 13/848,627

(22) Filed: Mar. 21, 2013

Related U.S. Application Data
(60) Provisional application No. 61/613,852, filed on Mar. 21, 2012.

(51) Int. Cl. A61H 39/04

(52) U.S. Cl. CPC A61H 39/04
USPC 606/204

(57) ABSTRACT

Embodiments of the present disclosure include a pad configured to relieve neck pressure and a method of manufacturing thereof. The pressure relief pad includes a flexible body configured to be folded into a sleeve. The pressure relief pad also includes at least one fastener configured to secure a first edge of the body over a second edge of the body when the body is folded. The pressure relief pad is configured to be worn on the back of a neck of a person.

### CROSS-REFERENCE TO RELATED APPLICATION(S) AND CLAIM OF PRIORITY

The present application claims priority to U.S. Provisional Patent Application Serial No. 61/613,852 filed Mar. 21, 2012, entitled “APPARATUS FOR RELIEVING NECK PRESSURE”. The content of the above-identified patent document is incorporated herein by reference.

### TECHNICAL FIELD

This disclosure is generally directed to pressure relief pads and more particularly to an apparatus configured to relieve pressure on the back of the neck caused by a string or strap of a bathing suit, blouse, or other garment.

### BACKGROUND

Upper body garments, such as bathing suits and blouses, often are secured by fastening or tying straps of the garment behind the head of the wearer. If the garment is a supportive garment (i.e., a garment that supports some or all of the weight of the chest of the wearer), the supported weight can pull on the straps of the garment, causing a region of pressure on the back of the neck. This pressure zone can cause discomfort, redness, or even bruising on the back of the neck. The pressure can be particularly pronounced at the knot formed by the tied straps.

### SUMMARY

According to one embodiment of the present disclosure, a pressure relief pad includes a flexible body configured to be folded into a sleeve. The pressure relief pad also includes at least one fastener configured to secure a first edge of the body over a second edge of the body when the body is folded. The pressure relief pad is configured to be worn on the back of a neck of a person.

In another embodiment, a pressure relief pad includes a flexible sleeve comprising a first opening at a first end of the sleeve and a second opening at a second end of the sleeve, the flexible sleeve configured to at least partially ensconce a strap worn around the back of a neck of a person. The pressure relief pad also includes a third opening formed through a layer of the flexible sleeve, the third opening positioned approximately equidistant from the first and second ends of the sleeve. The pressure relief pad is configured to be worn on the back of a neck of a person.

In still another embodiment a method of manufacturing a pressure relief pad includes providing a flexible body configured to be folded into a sleeve. The method also includes providing at least one fastener configured to secure a first edge of the body over a second edge of the body when the body is folded. The pressure relief pad is configured to be placed between a person's neck and a strap worn around the back of the person's neck that applies pressure to the back of the person's neck, such that the body of the pressure relief pad distributes the pressure over an area of the body

Other technical features may be readily apparent to one skilled in the art from the following figures, descriptions and claims.

### BRIEF DESCRIPTION OF THE DRAWINGS

For a more complete understanding of this disclosure and its features, reference is now made to the following description, taken in conjunction with the accompanying drawings, in which:

FIG. 1 illustrates a perspective view of a pressure relief pad according to an embodiment of this disclosure;

FIGS. 2A and 2B illustrate a top view of another pressure relief pad according to an embodiment of this disclosure;

FIGS. 3A through 3C illustrate top views of yet another pressure relief pad according to an embodiment of this disclosure;

FIGS. 4A through 4C illustrate perspective views of still other pressure relief pads according to embodiments of this disclosure; and

FIGS. 5A and 5B illustrate a method of using a pressure relief pad, according to an embodiment of the present disclosure.

### DETAILED DESCRIPTION

Pads configured to relieve pressure on the back of the neck are known in the art. A representative example is disclosed in U.S. Pat. No. 6,698,030. That patent discloses a flat, ellipsoidal foam pad having a series of holes through which the straps of a garment are threaded. In order to use the disclosed pressure relief pad, a wearer must thread the free ends of the garment straps or strings through the multiple holes of the pad while the pad is behind the wearer's head. Such a maneuver is very awkward and difficult to complete behind one's head. Furthermore, if the diameters of the holes in the pad are too small or the straps are too large in cross-section, it may be difficult or impossible to feed the free ends of the straps through the holes.

The present disclosure provides a pad configured to relieve pressure on the back of the neck caused by one or more strings or straps of a bathing suit, blouse, or other garment. The disclosed pressure relief pad is easily installed without having to remove the garment or untie strings or straps. Moreover, the disclosed pressure relief pad is not limited for use with garments. The disclosed pad can also be used for camera straps, or for any other weighted object worn around the neck and whose strap causes uncomfortable pressure on the back of the neck.

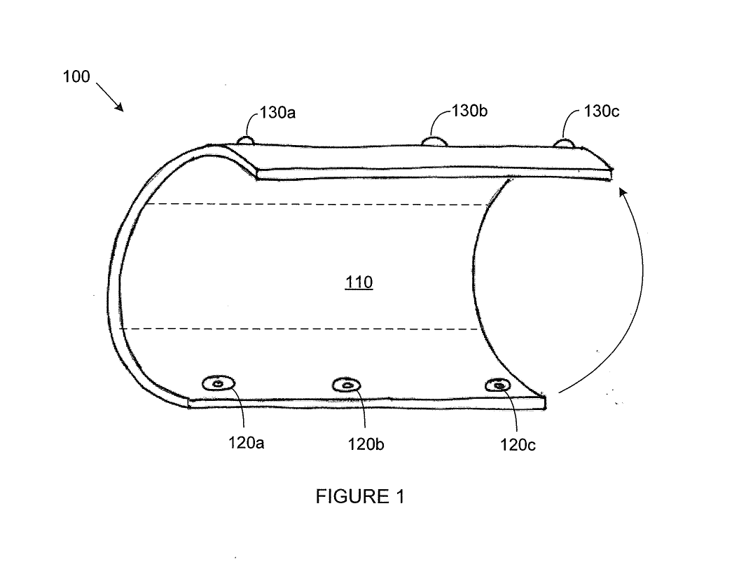

FIG. 1 illustrates a perspective view of a pressure relief pad according to an embodiment of this disclosure. The embodiment of the pressure relief pad shown in FIG. 1 is for illustration only. Other embodiments of the pressure relief pad could be used without departing from the scope of this disclosure.

As shown in FIG. 1, the pressure relief pad 100 comprises a body 110, one or more top fasteners 120a-120c, and one or more bottom fasteners 130a-130c. The body 110 of the pressure relief pad 100 is formed of a soft, flexible material, such as neoprene, polyurethane, closed cell foam, or any other suitable material. When one edge of the body 110 is brought over a second edge of the body 110 (as indicated by the curved arrow), the bottom fasteners 120a-120c and top fasteners 130a-130c are configured to fit together securely to form the pressure relief pad 100 into a closed sleeve. The sleeve is configured to fit around any strap or string that applies pressure to a person's neck. In an embodiment, the pressure relief pad 100 may be constructed to include fold lines (indicated by dotted lines) to facilitate the pad 100 to fold flat.

As shown in FIG. 1, the fasteners 120a-120c, 130a-130c represent top and bottom portions of multiple snaps. Each top snap portion 120a-120c snaps onto the corresponding bottom snap portion 130a-130c. It will be understood that snaps are one representative example of a suitable fastener. The fasteners 120a-120c, 130a-130c may represent hook-and-loop, buttons, zippers, clips, clasps, or any other suitable fastener(s). While the pressure relief pad 100 is shown with three snaps, other embodiments of the pad 100 may include more or fewer fasteners. For example, if the pressure relief pad 100 includes a hook-and-loop fastener, the hook-and-loop fastener may include a single hook strip and a single loop strip that are disposed along a majority of the length of the pad 100.

In one embodiment, the pressure relief pad 100 is approximately three inches by four inches. However, the pad 100 may be formed in different sizes. For example, the pad 100 may have a smaller or larger width or length. The length of the pad 100 may be determined in part based on the size of the wearer's neck. In one embodiment, the thickness of the pad 100 is approximately three millimeters. However, the pad 100 may have other thicknesses. The thickness of the pad 100 may be determined in part by the resilience of the material of the pad 100 and the desired amount of pressure relief on the neck. For example, a thinner pad that is formed of a stiffer material may be able to provide as much pressure relief to the neck as a thicker pad formed of a more compliant material.

The pressure relief pad 100 may include a decorative or stylish finish. For example, the inner or outer surface of the pad 100 may include one or more decorative features. As a particular example, the outer surface of the pad 100 may be decorated with a design representing a beach theme. Such a design might be desirable when the pad 100 is worn with a bathing suit. In other embodiments, the pad 100 may be usable with a decorative sleeve or sheath that is configured to fit around the pad 100 and conceal all or part of the pad 100.

Although FIG. 1 depicts one example of a pressure relief pad 100, various changes may be made to FIG. 1. For example, while the pad 100 is depicted as generally rectangular in shape, the pad 100 could include other shapes, such as a rounded rectangle or ellipse. As another example, the surface of the pressure relief pad 100 that is positioned to contact the skin may be a formed of a second material (such as a softer material) to provide even greater comfort for the wearer. As yet another example, the pad 100 may be formed of a plastic that can be manipulated to lay flat but will spring to a roughly cylindrical shape when pressure is applied to certain points on the pad. In such an embodiment, the pad 100 may not need any fasteners to hold the pad 100 in a closed configuration. As still another example, the pressure relief pad 100 may not form a closed sleeve that completely ensconces the strap. Instead, the pad 100 may only partially or substantially ensconce the strap.

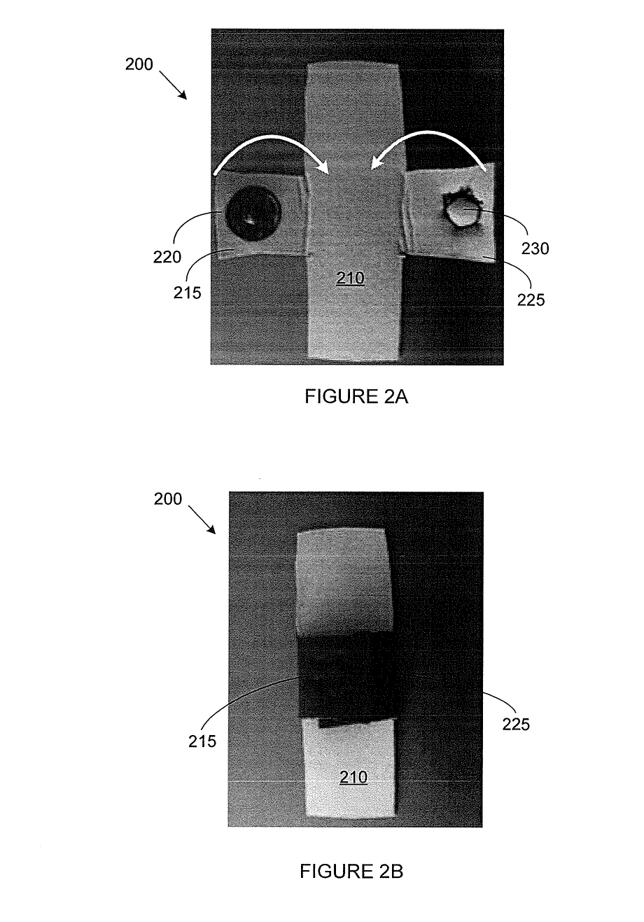

FIGS. 2A and 2B illustrate a top view of another pressure relief pad according to an embodiment of this disclosure. The pressure relief pad 200 includes many of the same or similar elements as the pressure relief pad 100 shown in FIG. 1. However, the pressure relief pad 200 has a different shape. As shown in FIG. 2A, the pressure relief pad 200 comprises an approximately cross-shaped body 210 having a top wing 215 and a bottom wing 225, a top fastener 220 on the top wing 215 of the body 210, and a bottom fastener 230 on the bottom wing 225 of the body 210. To close the pressure relief pad 200 over a strap, the top and bottom wings 215, 225 of the pressure relief pad 200 are folded over (as indicated by the arrows), with the top wing 215 overlapping the bottom wing 225. Then, the top fastener 220 is secured to the bottom fastener 230, thereby creating a closed pressure relief pad 200, as shown in FIG. 2B.

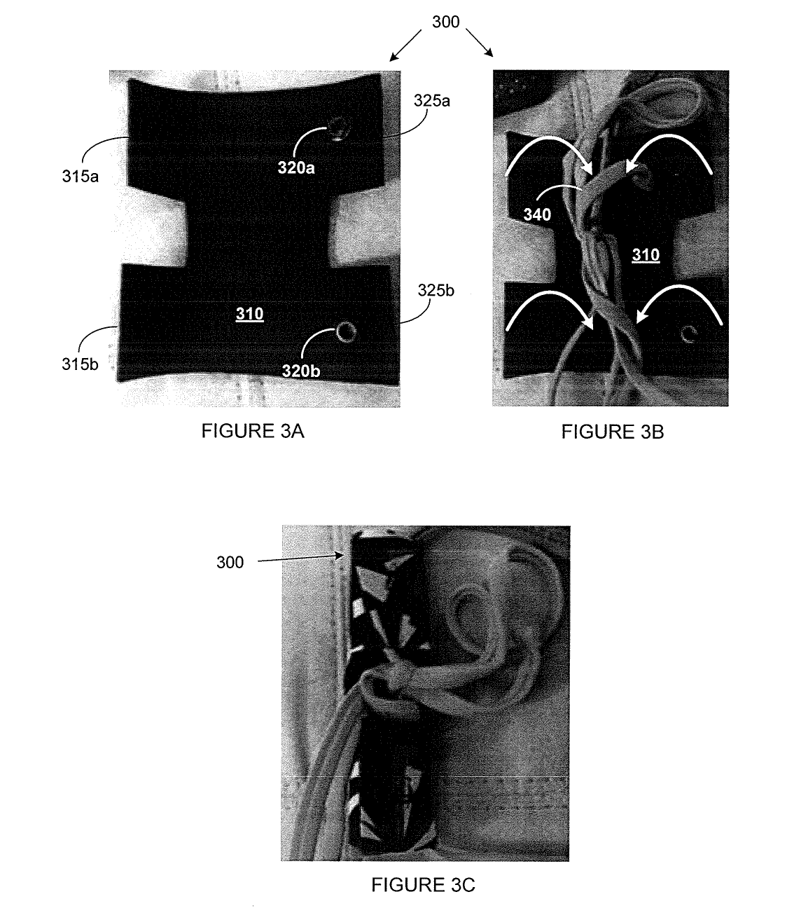

FIGS. 3A through 3C illustrate top views of yet another pressure relief pad according to an embodiment of this disclosure. The pressure relief pad 300 includes many of the same or similar elements as the pressure relief pad 100 shown in FIG. 1 and the pressure relief pad 200 shown in FIGS. 2A and 2B. However, the pressure relief pad 300 is formed in another shape. As shown in FIG. 3A, the pressure relief pad 300 comprises a body 310 that is approximately in the shape of a capital “I”. The body 310 includes two bottom wings 315a, 315b and two top wings 325a, 325b. Each top wing 325a, 325b includes a top fastener 320a, 320b. Each bottom wing 315a, 315b includes a bottom fastener (not shown) on the reverse side.

As shown in FIG. 3B, a tied bathing suit strap 340 is placed over the body 310. To close the pressure relief pad 300 over the strap 340, the top and bottom wings 315a, 315b, 325a, 325b are folded over (as indicated by the arrows), with the top wings 325a, 325b overlapping the corresponding bottom wings 315a, 315b. Then, the top fasteners 320a, 320b are secured to the bottom fasteners, thereby creating a closed pressure relief pad 300, as shown in FIG. 3C. The bow and knot of the tied strap 340 project from an opening in the closed pressure relief pad 300 formed between the wings 315a, 315b, 325a, 325b. The embodiment shown in FIGS. 3A through 3C is useful when the bow or knot is bulky, thus making it more difficult to close the wings of the pressure relief pad over the bow or knot.

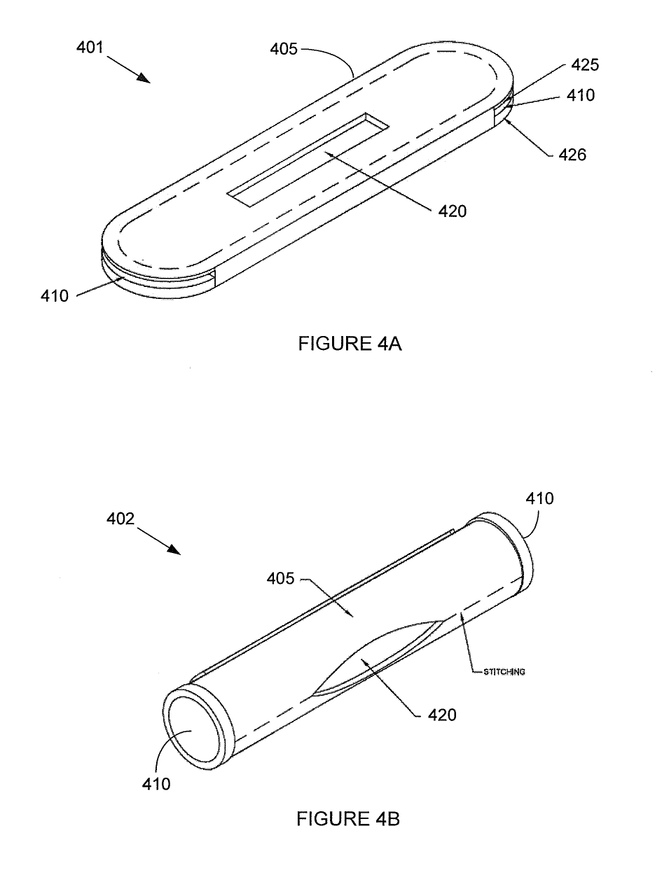

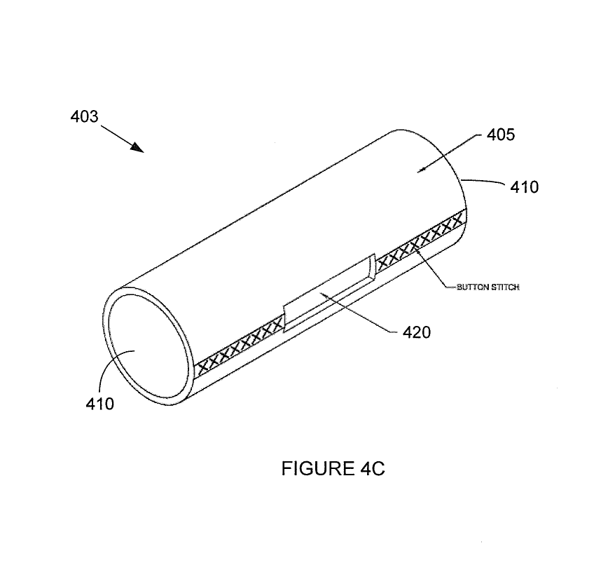

FIGS. 4A through 4C illustrate perspective views of a number of other pressure relief pads according to embodiments of this disclosure. The pressure relief pads 401-403 include many of the same or similar elements as the pressure relief pads 100-300 shown in FIGS. 1 through 3C. However, the pressure relief pads 401-403 are formed in other shapes.

Each of the pressure relief pads 401-403 is formed in the shape of an elongated, sleeve 405, with an opening 410 at each end of the sleeve 405. The body 405 is formed of a soft, flexible material, such as neoprene, polyurethane, closed cell foam, or any other suitable material. The sleeve 405 may be substantially flat, as shown in FIG. 4A, or may be substantially cylindrical, as shown in FIGS. 4B and 4C. The sleeve 405 may have any other suitable shape.

Another opening 420 is formed through one wall or layer of the sleeve 405. The opening 420 is elongate and is positioned approximately equidistant from each end of the sleeve 405. The opening 420 may be substantially rectangular, as shown in FIGS. 4A and 4C, or may have a more oval shape, as shown in FIG. 4B. The opening 420 may have any other suitable shape.

As discussed above, the pressure relief pad 401 includes a substantially flat sleeve 405. In some embodiments, the sleeve 405 may be formed of two layers 425, 426 that have different thicknesses. In one example embodiment, the top layer 425 is approximately one sixteenth of an inch thick, and the bottom layer 426 is approximately one eighth of an inch thick. The sleeve 405 of the pressure relief pads 402, 403 is formed of one cylindrical layer that is approximately one sixteenth of an inch thick. It will be understood that other suitable thicknesses are possible.

In one aspect of operation, one free end of a bathing suit strap is threaded into one opening 410 at one end of the sleeve 405 and out the opening 420. A second free end of a bathing suit strap is threaded into the opening 410 at the other end of the sleeve 405 and out the opening 420. The two free ends of the bathing suit strap can then be tied or otherwise secured together.

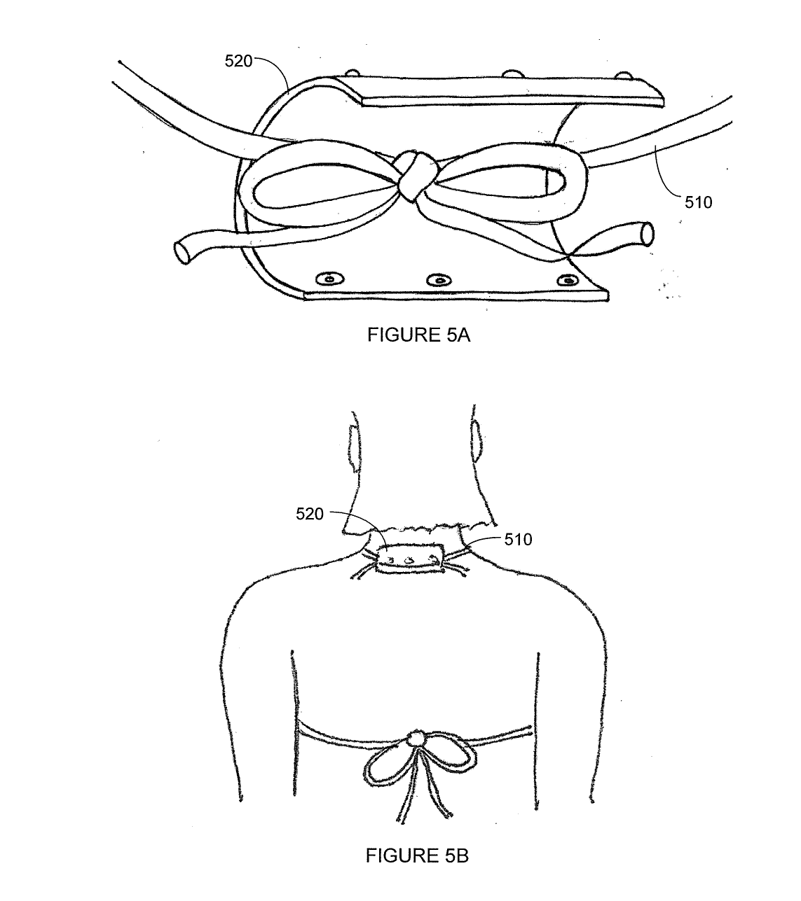

FIGS. 5A and 5B illustrate a method of using a pressure relief pad, according to an embodiment of the present disclosure. The embodiment of the pressure relief pad shown in FIGS. 5A and 5B is for illustration only. Other embodiments of pressure relief pad could be used without departing from the scope of this disclosure.

In one aspect of operation, a person wears a bathing suit top, a blouse, or another garment having a support strap 510 that goes around the back side of the person's neck. The strap 510 may include two separate lengths that are tied together in a knot or bow behind the neck. Alternatively, the strap 510 may be formed of a single length having no tied ends.

As shown in FIG. 5A, an open (i.e., unfastened) pressure relief pad 520 (such as the pressure relief pad 100 shown in FIG. 1 or the pressure relief pad 200 shown in FIG. 2) is positioned on the back of the neck underneath the strap 510, such that the pad 520 is between the neck and the strap 510, and the strap 510 rests over the open pad 520. Next, as shown in FIG. 5B, edges of the pad 520 are bent or folded over the strap 510 (and over any bow or knot in the strap 510) and secured together with one or more fasteners. Friction causes the closed pad 520 to resist sliding laterally, thus maintaining its position on the back of the neck.

The pressure relief pad 520 is easily installed or removed while the person is wearing the strap 510 around the person's neck. Thus, a person does not need to remove the associated garment or untie the strap 510 to install or remove the pad 520.

It may be advantageous to set forth definitions of certain words and phrases used throughout this patent document. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A pressure relief pad, comprising:
a flexible body configured to at least partially ensconce a strap worn around the back of a neck of a person; and
at least one fastener configured to secure a first edge of the body to a second edge of the body,
wherein the pressure relief pad is configured to be worn on the back of the neck of the person.

2. The pressure relief pad of claim 1, wherein the strap worn around the back of the person's neck applies pressure to the back of the person's neck, the pressure relief pad configured to be placed between the person's neck and the strap, such that the body of the pressure relief pad distributes the pressure over an area of the body.

3. The pressure relief pad of claim 2, wherein the pressure relief pad is configured to be installed and secured on the back of the person's neck without untying the strap or removing the strap from around the back of the person's neck.

4. The pressure relief pad of claim 1, wherein the body of the pressure relief pad is formed of closed cell foam.

5. The pressure relief pad of claim 1, wherein the body of the pressure relief pad is formed of neoprene.

6. The pressure relief pad of claim 1, wherein the body comprises a second material on a surface of the body that contacts the neck of the person.

7. The pressure relief pad of claim 1, wherein the at least one fastener is one of a hook and loop fastener and a snap.

8. The pressure relief pad of claim 1, wherein the flexible body comprises a first wing and a second wing, the wings configured to be folded over the body, and wherein the fastener is configured to secure the first wing to the second wing when the wings are folded over the body.

9. A pressure relief pad, comprising:
a flexible sleeve comprising a first opening at a first end of the sleeve and a second opening at a second end of the sleeve, the flexible sleeve configured to at least partially ensconce a strap worn around the back of a neck of a person; and
a third opening formed through a layer of the flexible sleeve, the third opening positioned approximately equidistant from the first and second ends of the sleeve,
wherein the pressure relief pad is configured to be worn on the back of a neck of a person.

10. The pressure relief pad of claim 9, wherein at least one layer of the pressure relief pad is configured to be placed between the person's neck and a strap worn around the back of the person's neck that applies pressure to the back of the person's neck, such that the sleeve of the pressure relief pad distributes the pressure over an area of the body.

11. The pressure relief pad of claim 9, wherein the sleeve of the pressure relief pad is formed of closed cell foam.

12. The pressure relief pad of claim 9, wherein the sleeve of the pressure relief pad is formed of neoprene.

13. The pressure relief pad of claim 9, wherein the sleeve comprises a first layer configured to contact the neck of the person and a second layer comprising the layer having the third opening.

14. The pressure relief pad of claim 9, wherein the sleeve is substantially cylindrical in shape.

15. A method of manufacturing a pressure relief pad, the method comprising:
providing a flexible body configured to be folded into a sleeve; and
providing at least one fastener configured to secure a first edge of the body over a second edge of the body when the body is folded,
wherein the pressure relief pad is configured to be placed between a person's neck and a strap worn around the back of the person's neck that applies pressure to the back of the person's neck, such that the body of the pressure relief pad distributes the pressure over an area of the body.

16. The method of claim 15, wherein the pressure relief pad is configured to be installed and secured on the back of the person's neck without untying the strap or removing the strap from around the back of the person's neck.

17. The method of claim 15, wherein the body of the pressure relief pad is formed of closed cell foam.

18. The method of claim 15, wherein the body of the pressure relief pad is formed of neoprene.

19. The method of claim 15, wherein the body comprises a second material on a surface of the body that contacts the neck of the person.

20. The method of claim 15, wherein the at least one fastener is one of a hook and loop fastener and a snap.
